(19) United States
(12) Patent Application Publication
(10) Pub. No.: US 2019/0264498 A1
(43) Pub. Date: Aug. 29, 2019

(54) WINDOW PANEL SYSTEM

(71) Applicant: Hawkes Design and Consulting, LLC, Charleston, SC (US)

(72) Inventor: Henry Muhler Hay, III, Charleston, SC (US)

(73) Assignee: Hawkes Design and Consulting, LLC

(21) Appl. No.: 16/384,142

(22) Filed: Apr. 15, 2019

Related U.S. Application Data
(63) Continuation-in-part of application No. 16/242,392, filed on Jan. 8, 2019.
(60) Provisional application No. 62/614,687, filed on Jan. 8, 2018.

(51) Int. Cl. E06B 9/02; E06B 5/12

(52) U.S. Cl. CPC E06B 9/02; E06B 2009/005; E06B 5/12

(57) ABSTRACT

A temporary panel and panel system. The panel system comprises a fabric held in a two-part, snap-together window panel system. The panel system is attachable to a window trim system to secure it temporarily until fasteners can be driven into the panel system and the channel of the window frame. The window trim includes a fastener boss that helps to hold the fasters that hold the panel to the window frame. The fabric of the panel system is made of a geotextile. The marginal edge of the geotextile may be coated with urethane adhesive before being inserted between the two parts of the panel system. Placement of fasteners along the perimeter of the panel system is guided by a centering groove in the connector system that positions the fastener over a fastener boss in the window frame. The panel system, help temporarily in place to the window frame, may then be securely attached by fasteners driven into the panel frame.

### TECHNOLOGY FIELD

This specification relates to temporary coverings that protect windows against damage from strong winds.

### BACKGROUND

Storms are characterized by their strong winds. Strong winds apply pressure to windows of a building and blow dirt, sand, and debris at the windows. Windows may become abraded, damaged or broken as a result. Moreover, if a window of a building breaks from strong winds, the sudden pressure change inside the building may cause damage to interior property and structures.

Temporary coverings for protecting windows during a storm are well-known. See, for example, the coverings of Sanford (U.S. Pat. No. 5,603,190), Pelton (U.S. Pat. No. 6,705,054), Framer (U.S. patent Publication 2010/0146881), Diamond (U.S. Pat. Nos. 6,289,642 and 6,898,907), Bori (U.S. Pat. No. 6,502,355), and Hughes (U.S. Pat. No. 6,314,689).

However, there remains a need for an effective window panel installation system and that protects the window against strong winds and that may be installed over a window temporarily, quickly, safely, and securely.

### SUMMARY

According to its major aspects and briefly recited, herein is disclosed a window panel system for use in protecting a window against strong winds. The present window panel system comprises window trim, a frame, a fabric, and fasteners. The frame grips the fabric to form a panel. The panel may then be applied to the window trim.

The panel and window frame are configured to hold together without fasteners so that the user can then apply fasteners without also holding the panel to the window trim. Because windows may often be at an elevation great enough on a home or building so as to require a ladder to reach the panel to the window trim, this feature of being able to attach the panel to the window trim and then be able to apply fasteners to secure the panel to the window frame without holding on to the panel, particularly when standing on a ladder, is an advantage of the present window protection system.

The window trim may include an integral screw boss for receiving and holding fasteners so the panel may be securely held to the building, which is a feature of the disclosed window protection system.

The fasteners used to hold the panel to the window trim may be screws, and may be screws that are self-tapping and with integral washers that are independent of the screw shaft, and have a head that is driven with a driver dissimilar to those commonly available as a way thwart theft. These are additional features of the present disclosure.

The fabric is attached to the frame by trapping it between a first part and a second part of the frame. The first part and the second part snap together window trim traps the marginal edge of the panel between a first part and a second part of the frame that then the first part and second part are snapped together for a secure hold of the panel.

The panel may include a fabric, such as a geotextile for strength and weather resistance, another feature of the disclosure.

Fasteners may be applied at any interval along the linear perimeter of the frame. Specific locations are not required so fasteners may be spaced as convenient by the user on installation. Satisfactory lateral placement of the fasteners along the periphery of the window trim is guided by a centering groove so that the fasteners enter the screw boss. The centering groove and the absence of linear spacing requirements are features of the disclosure as they facilitate installation of the frame shorten installation time

Those skilled in the art of windows and window protection will appreciate the many other features and their advantages of the present window protection system from a careful reading of the follow detailed description of the system, accompanied by the drawings.

### BRIEF DESCRIPTION OF THE DRAWINGS

In the drawings:

FIG. 1 is a flow diagram of a method of making a panel for covering a window, according to an aspect of the disclosure;

FIG. 2 is an exploded, perspective, cross-sectional view of a two-part frame and a fabric that, together, form the panel, according to an aspect of the disclosure;

FIG. 3 is an assembled, cross-sectional, side view of the panel, according to an aspect of the disclosure;

FIG. 4 is a cross-sectional, partially-exploded, end view of the panel of FIG. 3 temporarily secured to window trim that includes a screw boss, using a fastener and washer, the fastener being shown poised above a centering groove of the two-part frame, according to an aspect of the disclosure;

FIG. 5 is a flow diagram of an alternative method of making a protective panel for covering a window, according to another aspect of the disclosure;

FIGS. 6 and 7 are cross-sectional end views of a first part and a second part, respectively, of a two-part frame for a panel, according to another aspect of the disclosure;

FIG. 8 is a cross-sectional, partially-exploded, side view of a panel being temporarily attached to a window trim, the trim having a fastener boss, and which fabric panel is to be attached, using a washer and a fastener, at the centering groove of the first part of the two-part frame to the window trim, according to the second aspect of the disclosure;

FIGS. 9A, 9B, 9C and 9D represent a series of steps for a first part and a second part of an alternative frame to secure a marginal edge of a fabric, wherein the marginal edge of the fabric is held in its initial position in a second part of the frame in FIG. 9A, forced into a channel in second part of frame in FIG. 9B, and below a first part of frame in FIG. 9C, and with the fabric between first part and second part of two part frame in FIG. 9D; and

FIG. 10 shows a portion of the panel of FIG. 9D in an exploded view with a screw with integral washer above it and window trim below it.

### DETAILED DESCRIPTION

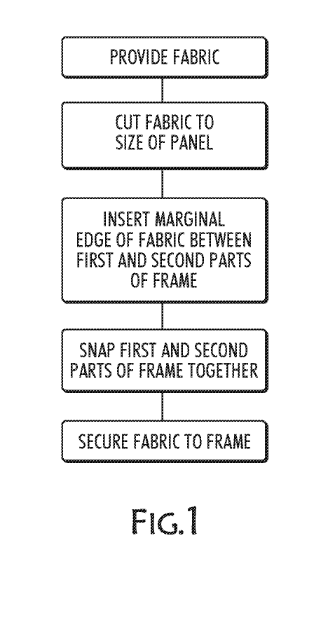

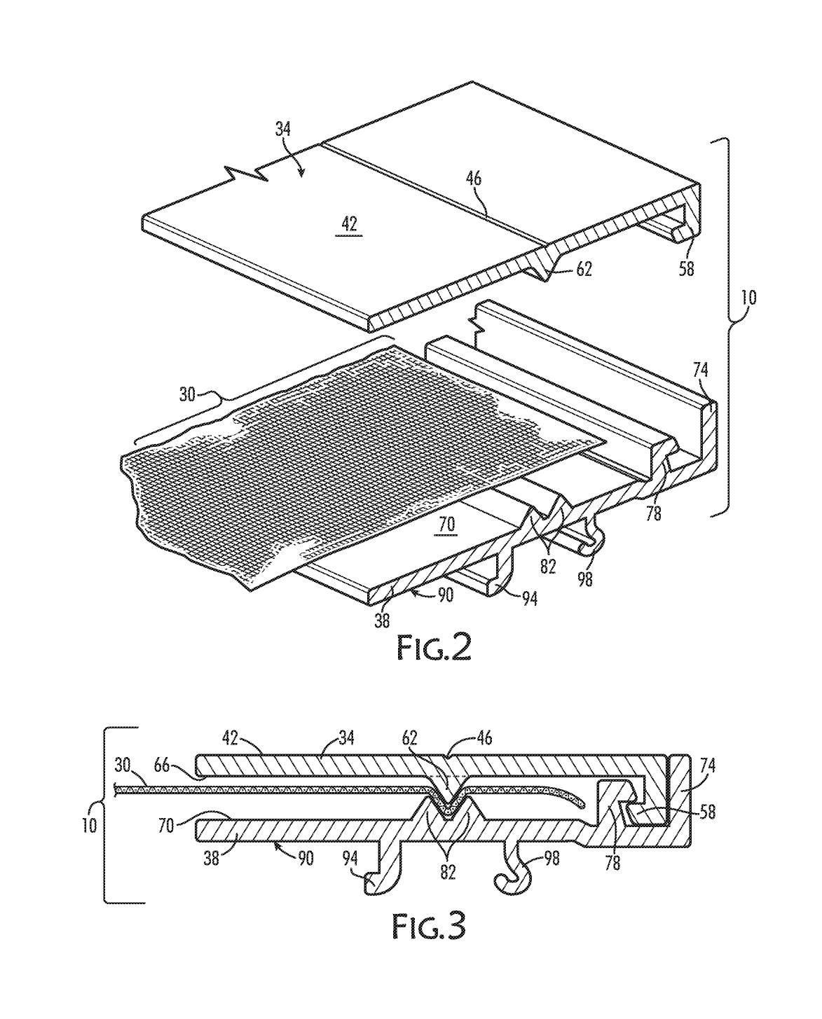

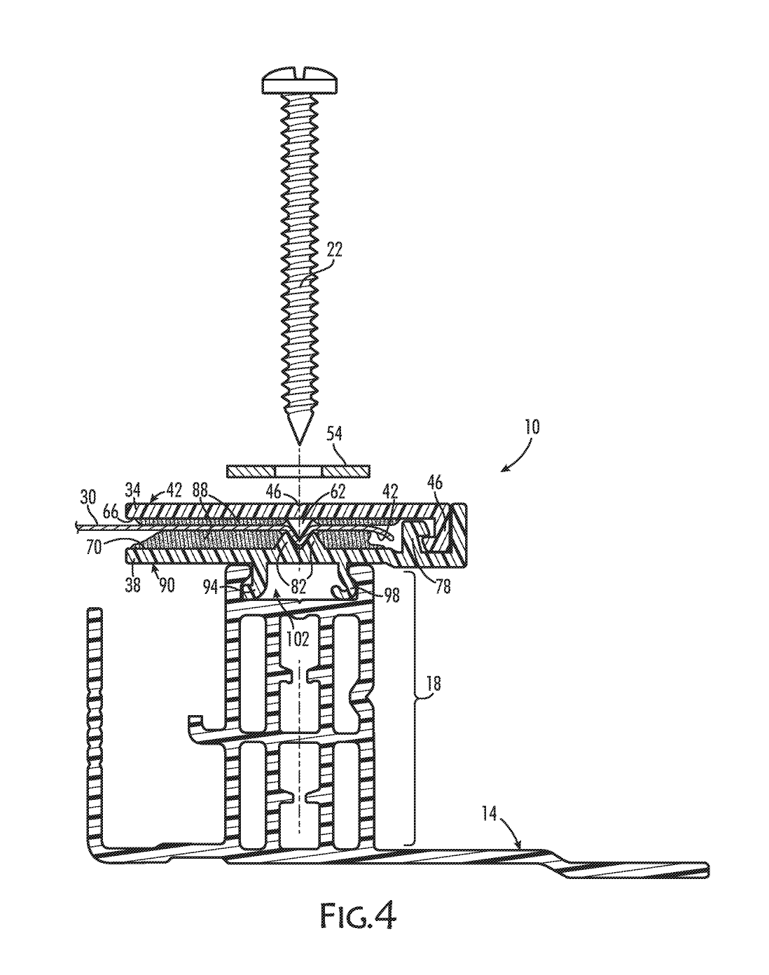

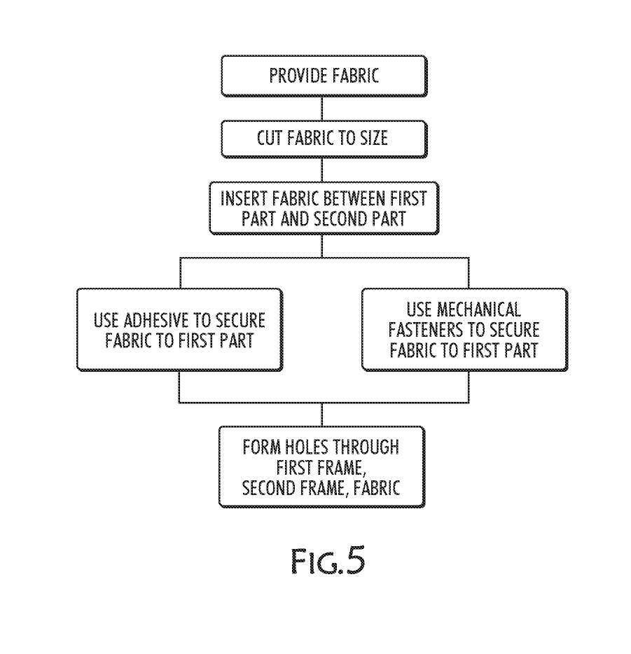

Referring first to FIGS. 1-4, herein is disclosed a panel 10 that, in cooperation with window trim 14, provides a window panel system providing protection from strong winds. The steps for a method for making panel 10 are described in FIG. 1. Panel 10 is shown by itself in FIGS. 2 and 3, and shown with an example of window trim 14 in FIG. 4.

As will be described more fully herein, panel 10 is attached to window trim 14 initially without fasterners. Panel 10 may be snapped into position on window trim 14 in order to hold panel 10 temporarily in place. Window trim 14 provides holding power to hold panel 10 without fasteners. The initial attachment between panel 10 and window trim 14 uses friction and mechanical interference to hold panel 10 in place. After the panel 10 is held in place by window trim 14, the user can then proceed to fasten panel 10 to window trim 14 in anticipation of high winds, and can do so safely because the user has both hands available for installing the panel and for holding onto a ladder. For example, the installer can drive screws through panel 10 into window trim 14 using one hand to operate a power drill and the other hand to hold the screw initially and then operate the drill while holding the ladder.

Referring now in particular to FIGS. 2 and 3, panel 10 is made by providing a fabric 30 that is strong and may be robust against wind, rain, and sun damage, such as, for example, a geotextile. A geotextile is a permeable textile material commonly used to increase soil stability, provide erosion control or aid in drainage. Geotextiles are usually made of woven, needle-punched, heat-bonded. knitted or non-woven fibers and made of a synthetic polymer such as polypropylene fibers, polyester fibers, polyethylene fibers and polyamide fibers.

Fabric 30 is cut to size using a cutting means for cutting the type of fabric 30 chosen for panel 10, such as a laser cutter or heat knife for plastic fabrics, such as geotextiles.

Adhesive 70, which may be urethane, mechanical fasteners, staples or equivalent, may be applied as a bead of adhesive 70 to the marginal edge of fabric 30 that has been cut to help to secure fabric 30 to panel 10. The marginal edge is the portion of fabric 30 that fits between a first part 34 and a second part 38 of panel 10. The rest of fabric 30 is exposed inside the boundaries defined by panel 10.

Panel 10 is made of first part 34 and second part 38 which may be made of an extruded plastic such as polyvinyl chloride and may be extruded separately or may be extruded as one piece, which is then separated into first part 34 and second part 38, or folded longitudinally for use as integrally connected first part 34 and second part 38.

Once the marginal edge of fabric 30 with urethane adhesive 70 is in place between first part 34 and second part 38 of panel 10, first part 34 and second part 38 may be snapped together over fabric 30 to form panel 10.

The structural elements to which window trim 14 is attached when in use, such as studs, siding, bricks and the like, are not shown in FIG. 4. See for example U.S. Pat. No. 8,863,451, which is incorporated herein in its entirety by reference, for an example of structural elements used with a window trim 14. Some aspects of the specific design of window trim 14 may vary to accommodate the type of wall structure and its materials.

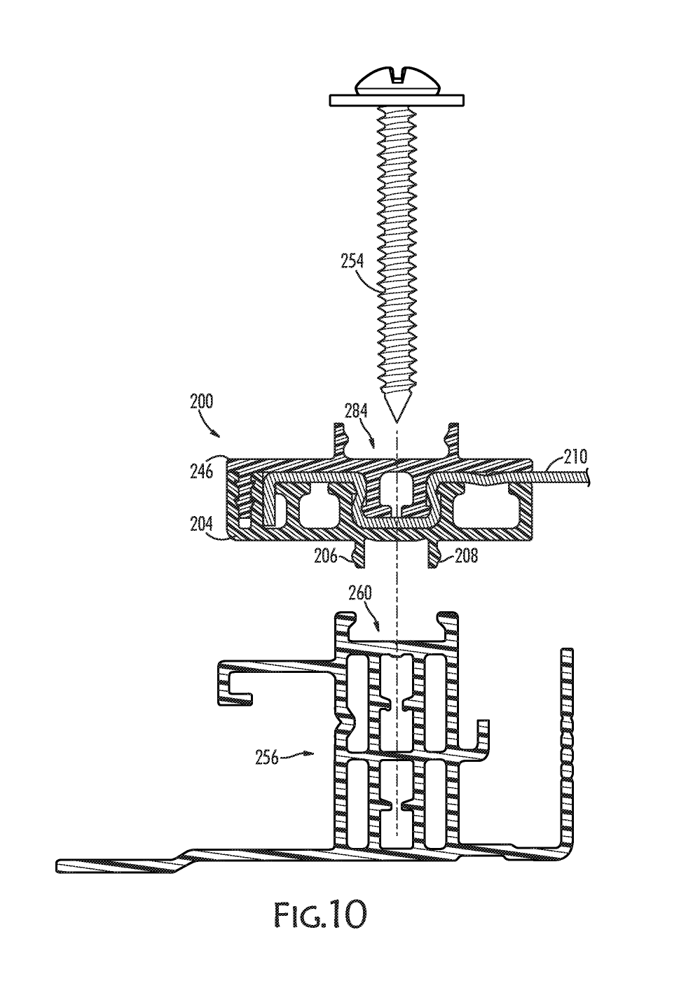

Window trim 14 may include a screw boss 18, as seen in FIG. 4, to better hold a fastener 22 when securing panel 10 applied to window. A washer 54 may be used to distribute the pressure of fastener 22 when it is loaded against panel 10. Washer 54 may be separate from fastener 22, as shown in FIG. 4 or be integral with fastener as is fastener 258 in FIG. 10.

Fastener 22 may be a threaded screw, as shown in FIG. 4, and have a head that is driven by a less common driver, such as a T25W drive head, than a flat head, cross-slot, or hex head driver in order to limit unauthorized removal. Fastener 22 may also have a double-lobed thread so that driving fastener 22 does not damage screw boss 18 to the extent that re-use of window trim 14 is prevented.

Panel 10 includes a first part 34 and a second part 38, and a fabric 30. Fabric 30 is an aspect of the disclosure. Fabric 30 may be a “geo-fabric”, as stated above and, in this application as a protective covering for a window in stormy weather, geo-fabrics are well-suited. Fabric 30 is cut to the appropriate size for covering the window for which it is to be used. Fabric 30 may conveniently be cut by using a laser-cutting tool or a heated knife or blade.

First part 34 of panel 10 may have a generally flat top surface 42 with a centering groove 46. Centering groove 46 runs the length of first part 34, which may, for example, define the outline of a rectangle the size of the window to be protected. Centering groove 46 serves as an aid to the user when attaching panel 10 to window trim 14 and driving fastener into screw boss 18.

The user lines up panel 10 with screw boss 18 so that a fastener 22 may be driven through panel 10 starting at centering groove 46 and into screw boss 18. Plural fasteners 22 with washers 54 be inserted along centering groove 46 around the periphery of panel 10 and having any convenient spacing from one to the next. Fasteners 22 may be screws with integral washers or staples. Fastener 22 seats in screw boss 18, and screw boss 18 helps fastener 22 resist removal despite pressure from wind on panel 10. The linear spacing between fasteners 22 may vary; centering groove 46 helps to assure that the lateral position of the fasteners 22 is based on the location of centering groove 46. Screw boss 18 provides holding power for fasteners 22 and for panel 10 that is held to window trim 14 by that fastener 22.

As best seen in FIGS. 2 and 3, first part 34 of fabric panel 10 includes a depending connector 58 and a projection 62 that depends from a bottom surface 66 of first part 32. Second part 38 of panel 10 has a top surface 42 formed to receive depending connector 58. Depending connector 58 of first part 34 is receivable between an end wall 74 and a locking flange 78 so that depending connector 58 (and first part 34) is held between end wall 74 and locking flange 78 to secure first part 34 to second part 38. In addition, projection 62 on bottom surface 66 of first part 34 fits between teeth 82 on top surface 42 of second part 38. Projection 62 and teeth 82 help to hold fabric 30 when the wind blows.

Fabric 30, when cut for the particular window, has a marginal portion or edge along its periphery that is inserted between first part 34 and second part 38. After insertion, fabric 30, first part 34 and second part 38 form panel 10. The strength of the hold between first part 34 and second part 38 may be augmented by applying an adhesive bead 88, such as a urethane, to at least one side of marginal edge before it is inserted between first part 34 and second part 38.

The application of adhesive bead 88 to the marginal edge 86 of fabric 30 may be done conveniently using a “caulk” gun, for example. Adhesive bead 88 may be cured by the passage of time or by application of heat and a catalyst, according to the instructions provided by the manufacturer of the urethane adhesive.

Second part 38 has a bottom surface 90 on which is formed a first hook 94 and a spaced-apart second hook 98. First hook 94 and second hook 98 may be curved on their respective ends, and curved in the same direction, as shown in FIG. 4, to better engage a top opening 102 of screw boss 18. First hook 94 and second hook 98, when joined to screw boss 18, position centering groove 46 so that fastener 22, when driven through first part 34, fabric 30, and second part 38 at centering groove 46, will pass into screw boss 18.

First hook 94 and second hook 98 may be curved in the same direction so that they can be easily rotated into position when fabric panel 10 is to be snapped onto window trim 14 and rotated out of position when fabric panel 10 is is to be removed from window trim 14.

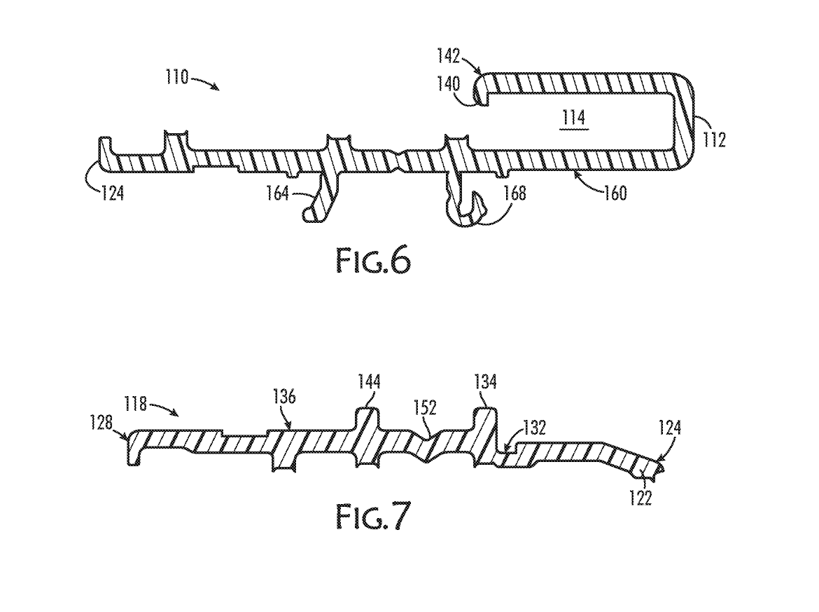

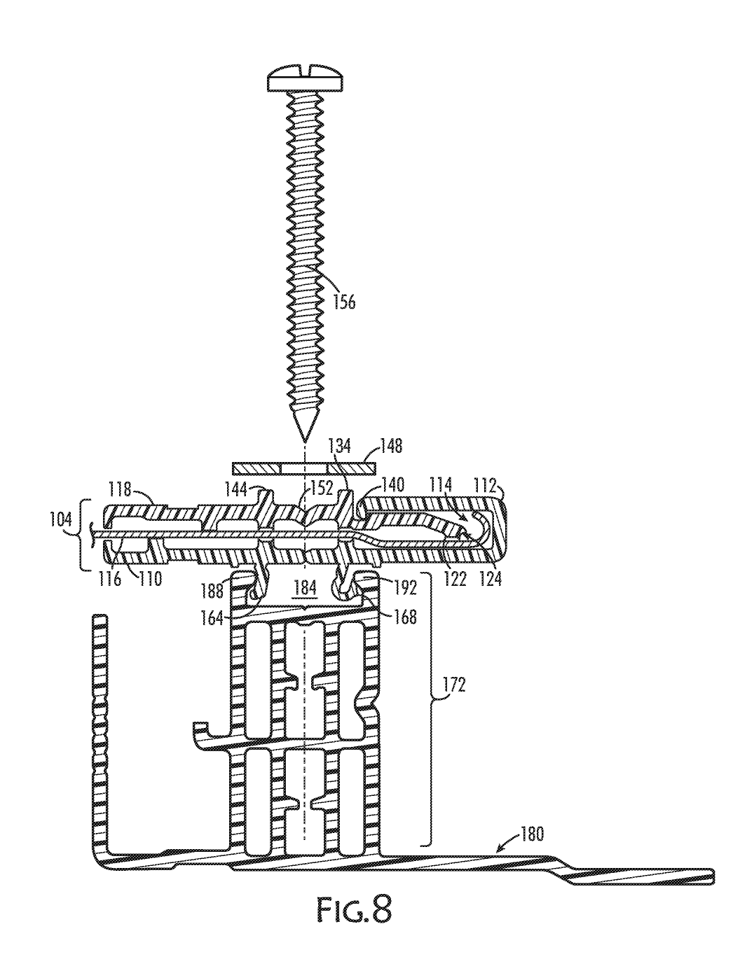

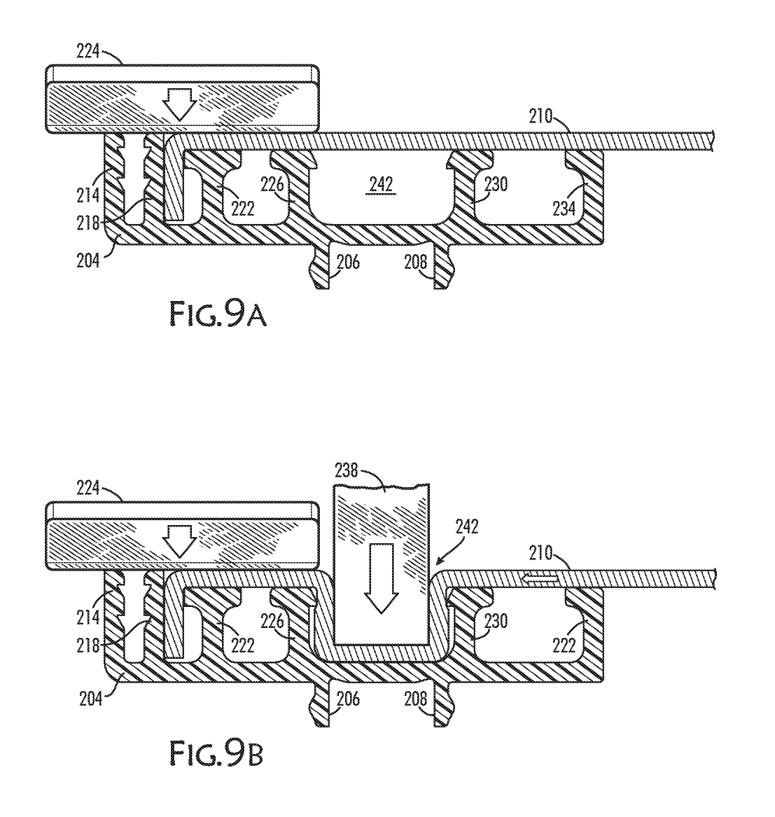

FIG. 5 shows the method for making a panel 104 according to a second aspect of the present panel; FIGS. 6 and 7 show first part 110 and second part 118, respectively, of panel 104 (FIG. 8), made according to the method of FIG. 5.

Fabric 116 is provided and cut to size for a panel 104. In this second aspect of the present disclosure, panel 104 has two parts. A first part 110 of panel 104 is formed to have a curve 112 (seen to the right in FIG. 6) which curve 112 thereby creating a channel 114 on the interior of curve 112. A marginal edge of fabric 116 may be inserted into channel 114.

A second part 118 of panel 104 is used to hold fabric 116 in channel 114. Second part 118 has a first end 124 and a second end 128. First end 124 has a limiter 122 to limit the depth to which second part 118 may be inserted into channel 114 of first part 110.

A locking groove 132 is formed in second part 118 of panel 104. Locking groove 132 is adjacent to a first ridge 134 on a top surface 136 of second part 118. Locking groove 132 receives, and first ridge 134 captures, a lip 140 at first end 142 of first part 110. Second part 118 is insertable into first part 110. When limiter 122 is seated in channel 114 and is in contact with first part 110, and when lip 140 is in locking groove 132, relative lateral movement of first part 110 with respect to second part 118 is limited. Second part 118 and a marginal portion of fabric 116 are thus held in place inside curve 112 of first part 110 of panel 104.

A second ridge 144 is also carried by second part 118 and spaced apart from first ridge 134 to provide resilient support for a washer 148 (best seen in FIG. 8). Between first ridge 134 and second ridge 144 is a centering groove 152 that serves to indicate to the user where a fastener 156 (FIG. 8) is to be positioned when attaching panel 104 to a window trim 176 (FIG. 8).

On bottom surface 160 of first part 110 is a first hook 164 and a second hook 168. First hook 164 and second hook 168 engage a screw boss 172, as best seen in FIG. 8. Screw boss 172, is part of a window trim 176. Screw boss 172 has a channel 184 defined by a first wall 188 and a spaced-apart second wall 192. Screw boss 172 serves to hold panel 104 and also to center centering groove 152 with respect to screw boss 172.

Once panel 104 is assembled, holes may be formed in it through panel 104 where fasteners 156 are to be placed to facilitate attachment. Holes may be formed in panel 104 using a hole punch to form them or by burning them. The holes may be slots, that is, holes that are longer in one dimension than in an orthogonal direction, to simplify attachment of panel 104 to window trim 176.

The present panel 104 avoids folding fabric 30, and the need for having to fold fabric 30 using folding equipment and the attendant costs of folding equipment and time, and increases manufacturing accuracy in producing panel 104. Panel 104 is typically half the weight of similar storm panels and considerable easier and safer for the installer.

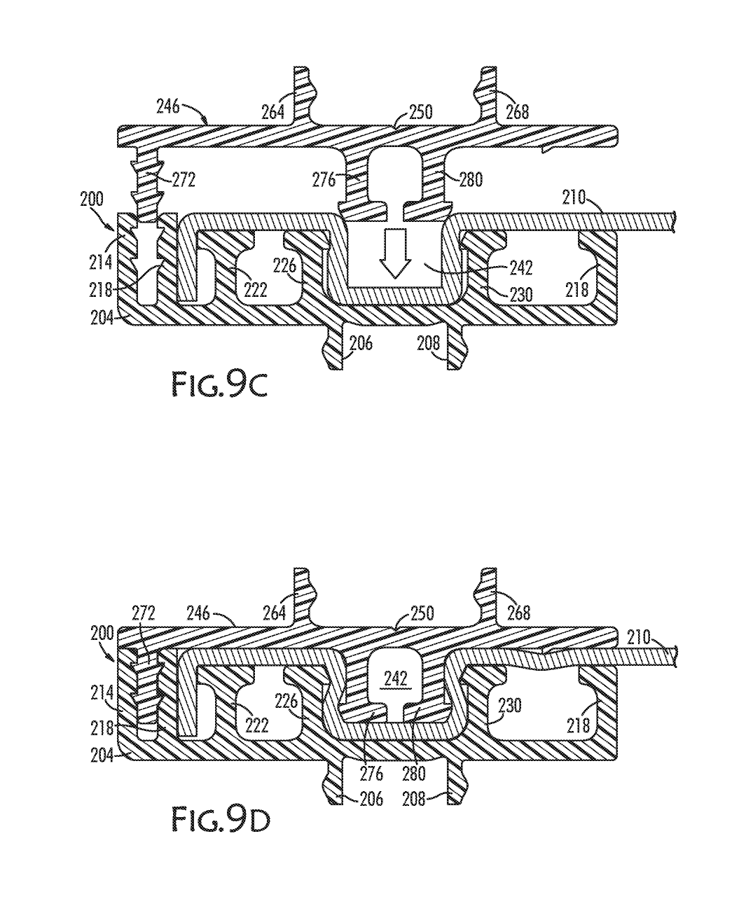

An alternative aspect of the present invention is shown in the series of figures identified as FIGS. 9A, 9B, 9C and 9D. FIGS. 9A, 9B, 9C, and 9D show steps in making a panel 200. FIG. 9A shows a first part 204 of a frame 196 in cross-section with a fabric 210 inserted between a interior wall 218 and a exterior column 222, where fabric 210 is held in place temporarily during manufacture by a first block 224. Fabric 210 runs across the tops of exterior column 222, left column 226, right column 230 and interior column 234. Fabric 210 may be made of a geo-textile.

FIGS. 9A, 9B, 9C, and 9D show the construction of a panel 200 and its attachment to a window trim 256. Panel 200 and window trim 256 are shown in cross section so the interaction of a first part 204 and a second part 245 with respect to fabric 210 to form panel 200 is clear. FIGS. 9A and 9B show first part 204 being prepared by loading fabric 210. FIG. 9C shows second part 246 being added to first part. FIG. 9D shows panel 200 assembled. FIG. 10 is an exploded view of panel about to be attached using a staple 254 to window trim 256.

Shown in full, panel 200 is a closed figure, typically a rectangle or square, which may have any closed shape. The left end of panel 200 shown in FIG. 9D may be the top and thus the “header” of a rectangular panel. The bottom or “sill” of panel 200 would be a mirror image of that shown in FIG. 9D. Accordingly, the left end of frame 196 in FIGS. 9A, 9B, 9C, and 9D is the exterior of frame 196 and the right end is the interior of the rectangle or other closed shape defined by frame 196.

Referring now to FIG. 9A, a fabric 210 is being applied to a first part 204 using a first block 224. First part 204 has an exterior wall 214 and an opposing interior wall 218. Fabric 210 is inserted on the interior (right) side of interior wall 218 and bent across first part 204. Fabric 210 passes over an exterior column 222 and then a left column 226, a right column 230 and finally an interior column 234, as first block 224 is used to hold fabric in place. On the underside of a first part 204 is a left tab 206 and a right tab 208. Between left column 226 and right column 230 is a channel 242. The purpose of left tab 206 and right tab 208 is to seat panel 200 to window trim 256.

In FIG. 9B, a second block 238 is used to force fabric 210 into a space between a left column 226 and a right column 230, as first block 224 holds fabric 210 in place between interior wall 218 and exterior column 222. Second block 238 pushes fabric 210 into channel 242 which is formed in first part 204 between left column 226 and right column 230, conforming fabric 210 to the shape of channel 242 including the left column 226 and right column 230 using the complimentary shapes of second block 238 and channel 242. As fabric 210 is forced into channel 242 and conforms to its shape, and as first block 224 holds fabric 210 in place, fabric 210 is pulled to the left in FIG. 9B (see arrow on fabric at right of FIG. 9B), thereby tightening fabric 210 in the interior of frame 196 of panel 200.

In FIG. 9C, first block 224 and second block 238 have been removed and a second part 246 is shown being lowered in place onto first part 204. Second part 246 is in registration with first part 204 of panel 200 so that the two fit together when pressed together.

Second part 246 includes a centering notch 250, that may be used to guide a staple 254 (FIG. 10) so that staple 25 staple 2546, when driven into panel 200, enters a screw boss 260 in window trim 256, as shown in FIG. 10.

Second part 246 includes a left rail 264 and a right rail 268 spaced apart from centering notch 250. Left rail 264 and right rail 268 may be used to attach a cap over groove to keep dust, dirt, rain, and debris away from centering notch 250.

Second part 246 has a locking flange 272 that locks to exterior wall 214 and interior wall 218 when seated between them. Exterior wall 214, interior wall 218 and locking flange 272 may carry ribs and grooves formed on their engaging surfaces, as seen by comparing FIGS. 9C and 9D, which cooperate to resist removal of second part 246 from first part 204.

Second part 246 carries a left latch 276 and a right latch 280. Left latch 276 interacts with left column 226 of first part 204 and right latch 280 interacts with right column 230 to hold fabric 210 in place in channel 242. Left latch 276 and right latch 280 may bend toward the other on insertion of second part 246 into first part 204 inasmuch as the leading edges of left latch 276 and right latch 280 are curved so as to be cammed by the top edges of left column 226 and right column, respectively, as second part 246 is pressed against first part 204, and then resiliently spread outward on reaching a full seating in channel 242, thereby locking second part 246 to first part 204 and fabric 210 therebetween as shown in FIG, 9D.

FIG. 10 is an exploded view of staple 254, panel 200, and window trim 256. Staple 254 in driven into panel 200 at centering notch 250 between left rail 264 and right rail 268 of second part 246 where it will pass between left latch 276 and right latch 280 and through fabric 210 and first part 204 emerging between left tab 206 and right tab 208 that seat between a left wall 284 and a right wall 288 of screw boss 260 of window trim 256.

Those skilled in the art of windows and window protections especially during storms and other high wind events will appreciate that many modifications and substitutions may be made to the aspects described without departing from the spirit and scope of the disclosure.

What is claimed is:

1. A window panel system, comprising:
(a) a window frame;
(b) a panel having
(i) a first part and a second part, said first part of said panel interlocking with said second part to form a frame,
(ii) a fabric having a marginal edge, said marginal edge operable to be received between said first part and said second part of said frame, said first part of said panel having a bottom surface configured to be held by said window frame without fasteners; and
(b) plural fasteners operable to attach said panel to said window frame.

2. The window panel system of claim 1, wherein said window frame includes a channel and wherein said bottom surface is operable to be held frictionally within said channel.

3. The window panel system of claim 1, wherein said bottom surface of said frame includes at least one hook, and wherein said bottom surface of said frame is held to said frame by said at least one hook.

4. The window panel system of claim 1, wherein said first part of said frame has a centering groove formed therein operable to guide insertion of said plural fasteners.

5. The window panel system of claim 1, wherein said fabric is a geotextile.

6. A window panel system, comprising:
(a) a window frame including a window trim;
(b) a panel having
(i) a first part,
(ii) a second part, said first part of said panel being interlocked with said second part to form a frame,
(iii) a fabric having a marginal edge, said marginal edge being between said first part and said second part of said frame, said first part having a bottom surface operable to be held by said window trim without fasteners; and
(c) plural fasteners operable to attach said panel to said window trim.

7. The window panel system of claim 6, wherein said window trim includes a channel and wherein said bottom surface of said frame is operable to be held frictionally within said channel.

8. The window panel system of claim 6, further comprising at least one hook carried by said bottom surface of said frame, and wherein said window trim includes a channel, and said frame is held to said channel of said window trim by said at least one hook.

9. The window panel system of claim 8, wherein said at least one hook includes a first hook and a second hook, and said first hook and said second hook are curved in the same direction.

10. The window panel system of claim 6, wherein said window trim includes a screw boss and wherein said screw boss is operable to receive said plural fasteners.

11. The window panel system of claim 6, wherein said first part of said frame includes a centering groove operable to position said plural fasteners laterally.

12. The window panel system of claim 6, wherein said fasteners are screws.

13. The window panel system of claim 6, wherein said fasteners are screws with integral washers.

14. The window panel system of claim 6, wherein said panel is a geotextile.

15. The window panel system of claim 6, wherein said panel is made of a synthetic polymer.

16. The window panel system of claim 6, wherein said panel is made of polypropylene fibers.

17. The window panel system of claim 6, wherein said panel is woven, needle punched, or heat bonded.

18. The window panel system of claim 6, further comprising a bead of adhesive between said first part and said second part of said frame.

19. The window panel system of claim 6, wherein said frame has holes formed therein through said first part and said second part and through said fabric

20. The window panel system of claim 19, wherein said holes through said first part and said second part of said frame are formed by melting holes in said frame.
